(19) United States
(12) Patent Application Publication
(10) Pub. No.: US 2003/0048881 A1
(43) Pub. Date: Mar. 13, 2003

(54) Method and apparatus for presenting information from telephone messages to a user

(75) Inventors: Miroslav Trajkovic, Ossining, NY (US); Srinivas Gutta, Buchanan, NY (US); Vasanth Philomin, Briarcliff Manor, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/951,862

(22) Filed: Sep. 13, 2001

(51) Int. Cl. H04M 1/64

(52) U.S. Cl. 379/88.12

(57) ABSTRACT

A method for presenting information from telephone messages to a user. The method including the steps of: receiving incoming telephone messages; recognizing speech in the incoming telephone messages by searching the incoming telephone messages for at least one predetermined category of information; and if the at least one predetermined category of information is found in the recognized speech, presenting the at least one predetermined category of information to the user.

### BACKGROUND OF THE INVENTION

1. Field of the Invention

The present invention relates generally to methods and apparatus for presenting information from telephone messages to a user, and more particularly, to methods and apparatus for recognizing categories of information in telephone messages and presenting the recognized information to the user in either a visual or audio presentation upon an instruction from the user.

2. Prior Art

Telephone message answering machines and voice mail message systems are well known in the art. If for some reason, a user cannot or does not wish to answer an incoming telephone call, the answering machine or voice mail system answers the telephone call and stores or records the message.

To retrieve the messages, a user must sequentially play the messages one at a time. Playing the messages typically involves pressing several buttons on the answering machine or voice mail system and may even involve the entry of a password. Additionally, important information in the messages is typically at or near the end of the message, such as the caller's telephone number or address. Therefore, the user must listen to the complete message in order to hear the important information.

Furthermore, answering machines and voice mail systems generally only alert a user as to the total number of calls that are received. For the most part, the user must listen to the messages in the order in which they are received. A user cannot otherwise receive a summary of important information contained in the messages and selectively listen to the messages in any order that may interest the user.

### SUMMARY OF THE INVENTION

Therefore it is an object of the present invention to provide methods and apparatus for presenting information from telephone messages to a user wherein the user does not have to listen to an entire message in order to retrieve important information from the message.

It is another object of the present invention to provide methods and apparatus for presenting information from telephone messages to a user wherein a user can be presented with a summary of important information from his or her messages.

It is still a further object of the present invention to provide methods and apparatus for presenting information from telephone messages to a user wherein a user can selectively listen to messages in any order based on a summary of information presented to the user.

It is yet still a further object of the present invention to provide methods and apparatus for presenting information from telephone messages to a user wherein the entry of manual commands and passwords are eliminated.

Accordingly, a method for presenting information from telephone messages to a user is provided. The method comprises: receiving incoming telephone messages; recognizing speech in the incoming telephone messages by searching the incoming telephone messages for at least one predetermined category of information; and if the at least one predetermined category of information is found in the recognized speech, presenting the at least one predetermined category of information to the user. Preferably, the at least one predetermined category of information is selected from a group consisting of caller name, recipient name, caller address, caller telephone number, and caller e-mail address.

Preferably, the method further comprises storing the incoming telephone messages prior to the recognizing step, wherein the recognizing step recognizes speech in the stored incoming messages.

If the at least one predetermined category of information is found in the recognized speech, the method preferably further comprises storing the recognized at least one predetermined category of information prior to the presenting step. The at least one predetermined category of information preferably comprises a plurality of predetermined categories of information and the storing step preferably comprises building a database wherein the plurality of predetermined categories of information are indexed according to category. The method more preferably further comprises constructing the database such that the plurality of predetermined categories of information from each incoming message are linked together.

The method can also further comprise instructing the presentation of the at least one predetermined category of information to the user. The instructing preferably comprises issuing a spoken command corresponding to the at least one predetermined category of information and recognizing the spoken command as corresponding to the at least one category of information. Alternatively, the instructing comprises issuing a manual command corresponding to the at least one predetermined category of information. The presenting step preferably comprises displaying a visual representation of the at least one category of information. Alternatively, the presenting step comprises playing an audio representation of the at least one category of information.

Also provided is a system for presenting information from telephone messages to a user. The system comprises: message receiving means for receiving incoming telephone messages; a speech recognition system for recognizing speech in the incoming telephone messages by searching the incoming telephone messages for at least one predetermined category of information; and presentation means for presenting the at least one predetermined category of information to the user.

The system preferably further comprises a memory for storing the incoming telephone messages prior to the recognition, wherein the speech recognition system recognizes speech in the stored incoming messages. More preferably, the system further comprises a memory for storing the recognized at least one predetermined category of information prior to its presentation to the user.

Preferably, the system also further comprises instruction means for instructing the presentation of the at least one predetermined category of information to the user. Preferably, the instruction means comprises the speech recognition system. Alternatively, the instruction means comprises a manual instruction means corresponding to the at least one predetermined category of information.

The presentation means preferably comprises a display for displaying a visual representation of the at least one category of information. Alternatively, the presentation means comprises a speaker for playing an audio representation of the at least one category of information.

The message receiving means is preferably either a telephone answering machine or a voice mail system.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic representation of a system for presenting information from telephone messages to a user.

FIG. 2 illustrates a schematic representation of an alternative system for presenting information from telephone messages to a user.

FIG. 3 illustrates a flowchart showing the preferred method steps for practicing the methods of the present invention.

### DETAILED DESCRIPTION OF THE PREFERRED EMBODIMENT

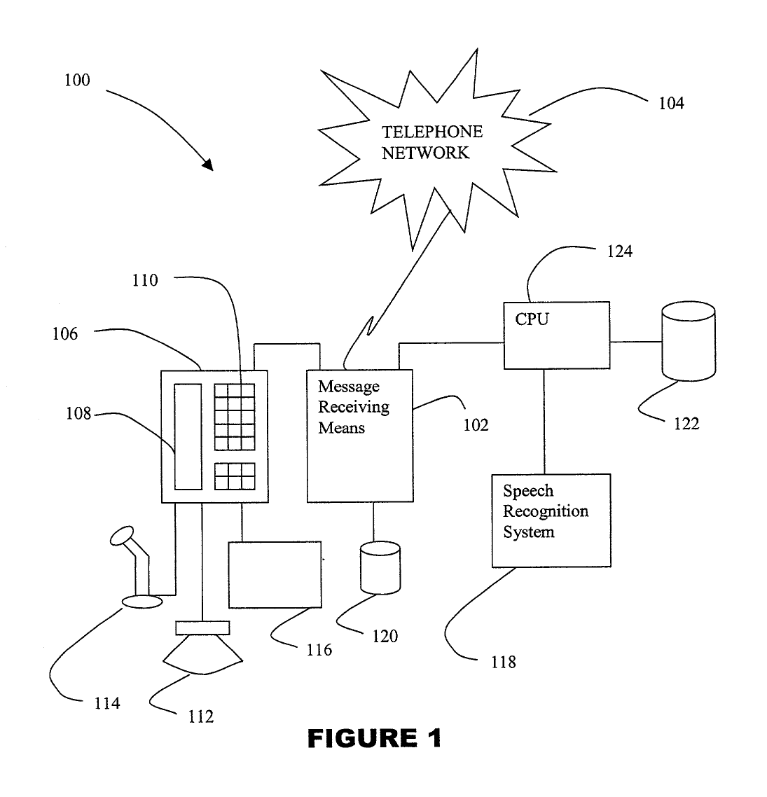

Referring now to FIG. 1, there is illustrated a first embodiment of a system for presenting information from telephone messages to a user, the system being generally referred to by reference numeral 100. The system 100 comprises a message receiving means 102 for receiving incoming telephone messages from a telephone network 104. The message receiving means 102 is preferably a telephone answering machine or a voice mail system, both of which are well known in the art. Generally, such message receiving means 102 receive an incoming telephone call, and if the call is not answered, it is recorded or stored for later retrieval and playback by the user.

The message receiving means is illustrated in FIG. 1 as being connected to a telephone system 106. The telephone system 106 is used by the user to make and receive calls and to retrieve messages from the message receiving means 102 as is well known in the art. The telephone system 106 has a handset 108 and a plurality of buttons 110 corresponding to various functions. The telephone system also has a speaker 112 for listening to messages or calls, a microphone 114 for transmitting the user's voice, and a display 116, typically an LCD, for viewing various types of information. The speaker 112, microphone 114, and display 116 can be integral with the telephone system or coupled separable therefrom. For instance, the speaker 112 and microphone 114, can be the receiver and transceiver incorporated into the handset 108.

The telephone network 104, message receiving means 102, and telephone system 106 are illustrated as having a wired link by way of example only and not to limit the scope or spirit of the present invention. For example, the same may also be linked wirelessly through a base station (not shown) where the telephone system 106 is a cellular telephone or a personal digital assistant (PDA). Furthermore, the telephone system 106 and message receiving means 102 are illustrated as separate elements of system 100, however, the message receiving means 102 can be integral with the telephone system 106 without departing from the scope or spirit of the present invention.

System 100 also includes a speech recognition system 118 for recognizing and understanding (hereinafter collectively referred to as “recognizing”) speech in the incoming telephone messages. The speech recognition system 118 can recognize the speech in the incoming messages “on the fly” as they are received. However, it is preferred that they are first stored in memory and the speech recognition system 118 recognizes speech in the stored incoming messages. The memory 120 can be the same as used by the message receiving means 102, or alternatively, the memory 122 can be under the control of a CPU 124 which preferably acts as a central command to control the entire 100. The speech recognition system 118 searches the incoming message for at least one predetermined category of information. The at least one predetermined category of information can be information such as the caller's name, the recipient's name (i.e., who the call is intended for if more than one person shares the system), the caller's address, the caller's telephone number, or the caller's e-mail address. Speech recognition systems are well known in the art for recognizing and understanding human speech.

Although shown separable in FIG. 1, the speech recognition system 118 and CPU 124 are preferably integrated into a single unit, such as in the message receiving means 102 or telephone system 106.

The at least one predetermined category of information preferably comprises a plurality of predetermined categories of information including but not limited to those listed above. Preferably, the system 100 stores the recognized categories of predetermined information by building a database wherein the plurality of predetermined categories of information are indexed according to category. For instance, all of the “caller telephone numbers” can be indexed together. However, the database is preferably constructed such that all of the predetermined categories of information from each incoming message are linked together.

The preferred system 100 illustrated in FIG. 1 also includes a presentation means for presenting the at least one predetermined category of information to the user. The predetermined categories can be presented to the user “on the fly”, for instance if a user is “screening” his or her calls, or preferably, stored in memory (120 or 122) prior to their presentation to the user. The presentation means can comprise the display 116 to display a visual representation of the at least one category of information to the user. The visual representation can be textual, graphical, or any combination thereof. Alternatively, the presentation means can comprise the speaker 112 to play an audio representation of the at least one category of information. The audio representation can be reproduced synthetically or the actual voice of the caller from the message can be reproduced.

Preferably, the system 100 illustrated in FIG. 1 also includes an instruction means for instructing the presentation of the at least one predetermined category of information to the user. The instruction means preferably comprises the speech recognition system 118, which recognizes spoken commands through the microphone 114 and carries out the appropriate command corresponding thereto. For instance, the user may issue a spoken command of “caller telephone numbers” and is presented with a summary of caller telephone numbers from the stored messages. Alternatively, the instruction means can comprise a manual instruction means corresponding to the at least one predetermined category of information. For instance, telephone system 106 can have buttons 110 corresponding to each of the predetermined categories of information. For example, a button 110 can correspond to “caller telephone numbers” which by depressing presents a summary of caller telephone numbers recognized in the messages.

After presentation, the user can then call any one of the caller's back or perhaps choose to selectively listen to any one of the messages, such as by issuing another spoken command, for instance “number 3” in which the message corresponding to the third caller telephone number displayed will be retrieved and played by the message receiving means 102. The user can also selectively listen to any of the messages corresponding to the presented categories of information in other ways, such as by pressing a button 110 on the telephone system 106 corresponding to the number on the list of information presented, for instance, by pressing the number “3” corresponding to the third listed caller telephone number. If the categories of information are presented on display 116, the display can have a touch screen capability, where a message corresponding to one of the displayed categories of information can be selected by touching the screen in the area where it is displayed.

Any one of the above selection means can also be employed to selectively view other predetermined categories of information recognized by the system 100 which, as discussed above, are preferably linked to the displayed category of information in the database. For instance, if a user instructs the system 100 to present a summary of “caller telephone numbers” and the user does not recognize one of the caller telephone numbers listed in the summary, the user can select the caller telephone number for presenting the other recognized categories of information linked with the caller telephone number, such as “caller name”. Means can be provided for differentiating between selectively playing messages and selectively presenting additional categories of information. For instance, if the speech recognition system 118 is employed, a spoken command of “message 3” can be used to play the third message on the displayed list and a spoken command of “summary 3” can be used to display additional categories of information that are linked with the third message on the displayed list.

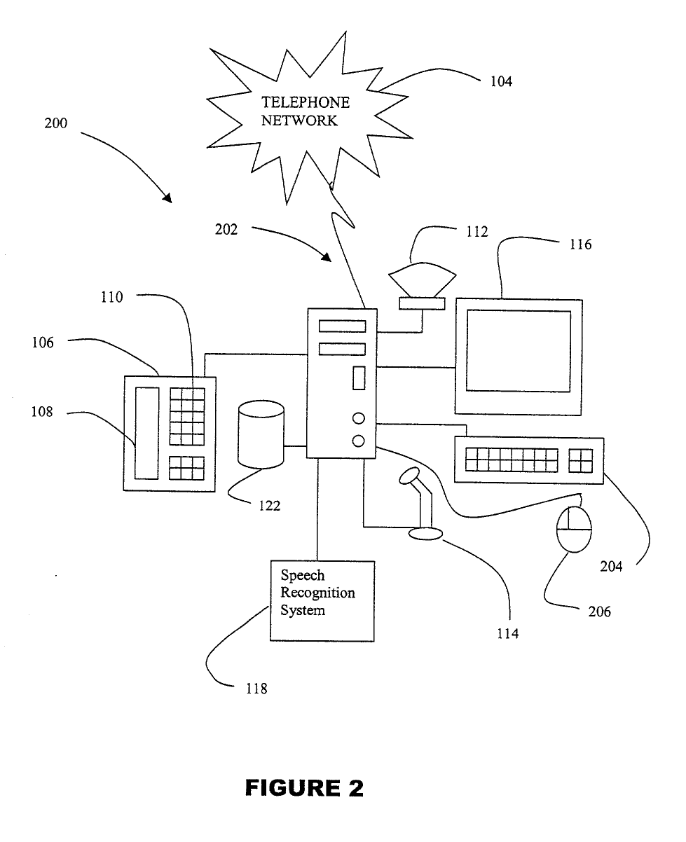

Referring now to FIG. 2 in which like numbers represent like features, an alternative embodiment of the system 100 is illustrated and generally referred to by reference numeral 200. In system 200, a computer system 202 is used to provide some of the features of system 100. The computer system 202 can have separable components as illustrated in FIG. 2 or the components can be integral, such as in a laptop computer or a PDA. Computer system 202 has a telephone system 106 connected thereto for receiving telephone calls from a telephone network 104. As described above, the telephone link can be wired or wireless. The computer system 202 preferably stores incoming telephone calls in memory 122. The speech recognition system 118 operates as described above with regard to system 100 to recognize speech in the messages and to search for predetermined categories of information in the messages.

The categories of predetermined information are presented to the user in the same way in system 200 as discussed with regard to system 100. However, the speaker 112 and display 116 which are part of the computer system 202 are used for such purposes in system 200. Furthermore, the instruction to present the categories of information and the selecting of the categories of information in system 200 are also similar to those discussed with regard to system 100. However, system 200 can also utilize the keyboard 204 and mouse 206 or any other input means of the computer system 202 for instructing the presentation of the categories of information and selecting any such categories from a displayed summary.

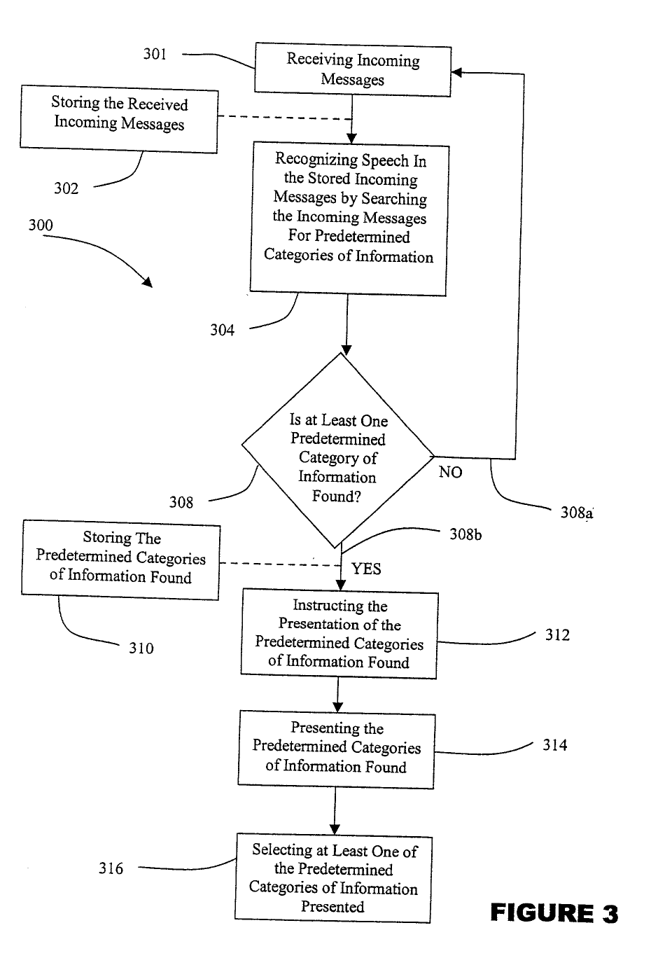

Referring now to FIG. 3, there is illustrated a flowchart summarizing the preferred steps of a method of the present invention for presenting information from telephone messages to a user. The method generally being referred to by reference numeral 300. At step 301, incoming telephone messages are received by the message receiving means 102, 202. At step 302 the incoming telephone messages are preferably stored.

At step 304, the speech in the incoming telephone messages is recognized by the speech recognition system and searched for at least one, and preferably a plurality of predetermined categories of information. At step 308 it is determined if any of the predetermined categories of information are found in the telephone message. If not, the method proceeds along path 308a where the method loops back to step 301. However, the method 300 does not have to loop back to step 300 which implies that a message is received and searched for speech before another message is received. More than one stored message or all of the stored messages can be searched for speech before another message is received, and preferably, the receiving of messages and the searching of the recognized speech in the stored messages can occur simultaneously, where necessary.

If at least one predetermined category of information is found in the recognized speech, the method continues along path 308b and the at least one predetermined category of information is preferably stored at step 310 before ultimately being presented to the user at step 314. Preferably, between steps 312 and 316, the user instructs the system at step 312 to present the predetermined categories of information. Preferably, after presentation, the user selects any one of the presented categories of information at step 316 for such actions as listening to a corresponding message, viewing additional categories of information linked thereto, or even to delete it from the summary.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for presenting information from telephone messages to a user, the method comprising:
receiving incoming telephone messages;
recognizing speech in the incoming telephone messages by searching the incoming telephone message for at least one predetermined category of information; and
if the at least one predetermined category of information is found in the recognized speech, presenting the at least one predetermined category of information to the user.

2. The method of claim 1, wherein the at least one predetermined category of information is selected from a group consisting of caller name, recipient name, caller address, caller telephone number, and caller e-mail address.

3. The method of claim 1, further comprising storing the incoming telephone messages prior to the recognizing step, wherein the recognizing step recognizes speech in the stored incoming messages.

4. The method of claim 1, if the at least one predetermined category of information is found in the recognized speech, further comprising storing the recognized at least one predetermined category of information prior to the presenting step.

5. The method of claim 4, wherein the at least one predetermined category of information comprises a plurality of predetermined categories of information and the storing step comprises building a database wherein the plurality of predetermined categories of information are indexed according to category.

6. The method of claim 5, further comprising constructing the database such that the plurality of predetermined categories of information from each incoming message are linked together.

7. The method of claim 1, further comprising instructing the presentation of the at least one predetermined category of information to the user.

8. The method of claim 7, wherein the instructing comprises issuing a spoken command corresponding to the at least one predetermined category of information and recognizing the spoken command as corresponding to the at least one category of information.

9. The method of claim 7, wherein the instructing comprises issuing a manual command corresponding to the at least one predetermined category of information.

10. The method of claim 7, wherein the presenting step comprises displaying a visual representation of the at least one category of information.

11. The method of claim 7, wherein the presenting step comprises playing an audio representation of the at least one category of information.

12. A system for presenting information from telephone messages to a user, the system comprising:
message receiving means for receiving incoming telephone messages;
a speech recognition system for recognizing speech in the incoming telephone messages by searching the incoming telephone message for at least one predetermined category of information; and
presentation means for presenting the at least one predetermined category of information to the user.

13. The system of claim 12, further comprising a memory for storing the incoming telephone messages prior to the recognition, wherein the speech recognition system recognizes speech in the stored incoming messages.

14. The system of claim 12, further comprising a memory for storing the recognized at least one predetermined category of information prior to its presentation to the user.

15. The system of claim 12, further comprising instruction means for instructing the presentation of the at least one predetermined category of information to the user.

16. The system of claim 15, wherein the instruction means comprises the speech recognition system.

17. The system of claim 15, wherein the instruction means comprises a manual instruction means corresponding to the at least one predetermined category of information.

18. The system of claim 12, wherein the presentation means comprises a display for displaying a visual representation of the at least one category of information.

19. The system of claim 12, wherein the presentation means comprises a speaker for playing an audio representation of the at least one category of information.

20. The system of claim 12, wherein the message receiving means is selected from the group consisting of a telephone answering machine and a voice mail system.

21. A program storage device readable by machine, tangibly embodying a program of instructions executable by the machine to perform method steps for presenting information from telephone messages to a user, the method comprising:
receiving incoming telephone messages;
recognizing speech in the incoming telephone messages by searching the incoming telephone messages for at least one predetermined category of information; and
if the at least one predetermined category of information is found in the recognized speech, presenting the at least one predetermined category of information to the user.

22. A computer program product embodied in a computer-readable medium for presenting information from telephone messages to a user, the computer program product comprising:
computer readable program code means for receiving incoming telephone messages;
computer readable program code means for recognizing speech in the incoming telephone messages by searching the incoming telephone messages for at least one predetermined category of information; and
if the at least one predetermined category of information is found in the recognized speech, computer readable program code means for presenting the at least one predetermined category of information to the user.
